(19) United States
(12) Patent Application Publication
(10) Pub. No.: US 2025/0119039 A1
(43) Pub. Date: Apr. 10, 2025

(54) ROTOR MANUFACTURING APPARATUS AND ROTOR MANUFACTURING METHOD

(71) Applicant: TOYOTA BOSHOKU KABUSHIKI KAISHA, Aichi-ken (JP)

(72) Inventors: Hiroyuki SAIKI, Toki-shi (JP); Keita NAMBA, Nagoya-shi (JP)

(73) Assignee: TOYOTA BOSHOKU KABUSHIKI KAISHA, Aichi-ken (JP)

(21) Appl. No.: 18/907,832

(22) Filed: Oct. 7, 2024

(30) Foreign Application Priority Data
Oct. 10, 2023 (JP) 2023-175284

(51) Int. Cl. H02K 15/03; B23K 26/21; H02K 1/276; H02K 1/28; H02K 1/32

(52) U.S. Cl. CPC H02K 15/03; B23K 26/21; H02K 1/276; H02K 1/28; H02K 1/32

(57) ABSTRACT

A rotor manufacturing apparatus includes a first welding device configured to weld a first end plate to a first end of a rotor core, a first detection unit configured to detect whether an end plate to be supplied to the first welding device is the first end plate, a second welding device configured to weld a second end plate to a second end of the rotor core having the first end plate welded to the first end, and a second detection unit configured to detect whether an end plate to be supplied to the second welding device is the second end plate.

### CROSS-REFERENCE TO RELATED APPLICATIONS

This application is tabled upon and claims the benefit of priority from prior Japanese Patent Application No. 2023-175284, filed on Oct. 10, 2023, the entire contents of which are incorporated herein by reference.

### BACKGROUND

### 1. Field

The present disclosure relates to a rotor manufacturing apparatus and a rotor manufacturing method.

### 2. Description of Related Art

Japanese Laid-Open Patent Publication No. 2020-114039 discloses a rotor including a rotor core and two end plates. The rotor core has insertion holes that respectively accommodate permanent magnets. The two end plates are respectively welded to the opposite ends of the rotor core in the axial direction.

Each end plate is welded to the rotor core to seal the openings of the insertion holes in the rotor core. This configuration prevents the permanent magnets accommodated in the insertion hole from protruding.

When the shapes of the two end plates welded to the opposite ends of the rotor core differ, there is a risk of erroneous coupling where an end plate different from the standard one is welded to one end of the rotor core.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

A rotor manufacturing apparatus for manufacturing a rotor according to an aspect of the present disclosure includes a rotor core with a first end and a second end located on opposite sides in an axial direction and includes two end plates respectively welded to the first end and the second end. The two end plates each have a different shape. The end plate welded to the first end is referred to as a first end plate. The end plate welded to the second end is referred to as a second end plate. The rotor manufacturing apparatus includes a first welding device configured to weld the first end plate to the first end, a first detection unit configured to detect whether an end plate to be supplied to the first welding device is the first end plate, a second welding device configured to weld the second end plate to the second end of the rotor core having the first end plate welded to the first end, and a second detection unit configured to detect whether an end plate to be supplied to the second welding device is the second end plate.

A rotor manufacturing method for manufacturing a rotor according to an aspect of the present disclosure includes a rotor core with a first end and a second end located on opposite sides in an axial direction and includes two end plates respectively welded to the first end and the second end. The two end plates each have a different shape. The end plate welded to the first end is referred to as a first end plate. The end plate welded to the second end is referred to as a second end plate. The rotor manufacturing method includes welding the first end plate to the first end using a first welding device, detecting whether an end plate to be supplied to the first welding device is the first end plate, welding, using the second welding device, the second end plate to the second end of the rotor core having the first end plate welded to the first end, and detecting whether an end plate to be supplied to the second welding device is the second end plate.

Other features and aspects will be apparent from the following detailed description, the drawings, and the claims.

### BRIEF DESCRIPTION OF DRAWINGS

FIG. 1 is an exploded perspective view of a rotor according to an embodiment.

FIG. 2 is a plan view of the first end plate shown in FIG. 1.

FIG. 3 is a plan view of the second end plate shown in FIG. 1.

FIG. 4 is a schematic diagram showing a rotor manufacturing apparatus in the embodiment.

FIG. 5 is a perspective view of the first jig and the first support table shown in FIG. 4.

FIG. 6 is a perspective view of the second jig and the second support table shown in FIG. 4.

FIG. 7 is a cross-sectional view of the first conveying device and the second conveying device shown in FIG. 4.

FIG. 8 is a cross-sectional view of the first detection unit used to detect the first end plate.

FIG. 9 is a cross-sectional view of the second detection unit used to detect the second end plate.

FIG. 10 is a side view illustrating the first welding device used to weld the first end plate to the rotor core.

FIG. 11 is a side view illustrating the second welding device used to weld the second end plate to the rotor core.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

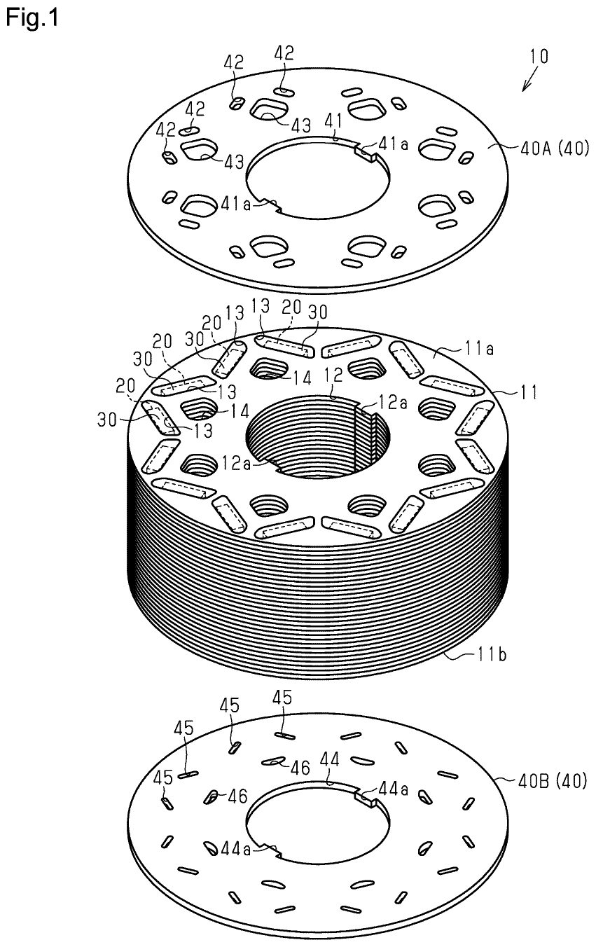

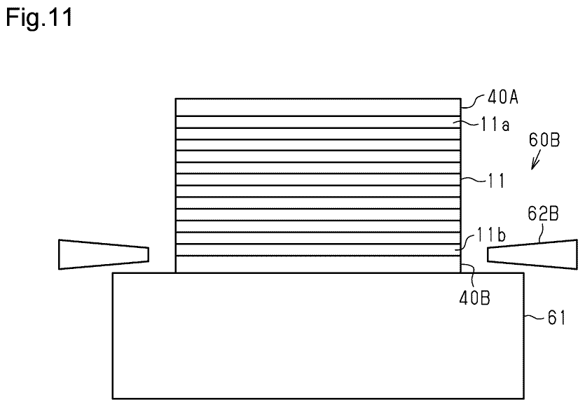

A rotor manufacturing apparatus and a rotor manufacturing method according to an embodiment will now be described with reference to FIGS. 1 to 11.

First, a rotor 10 manufactured by the rotor manufacturing apparatus will be described.

### Rotor 10

As shown in FIG. 1, a rotor 10 includes a rotor core 11, magnets 20, resin materials 30, and two end plates 40. The rotor 10 is, for example, a rotor used for a magnet-embedded motor.

### Rotor Core 11

The rotor core 11 is substantially cylindrical.

Hereinafter, the axial direction of the rotor core 11 will simply be referred to as the axial direction. The radial direction of the rotor core 11 will simply be referred to as the radial direction. The circumferential direction of the rotor core 11 will simply be referred to as the circumferential direction.

The rotor core 11 is formed, for example, by stacking iron core pieces that are punched out of an electrical steel sheet.

The rotor core 11 includes a first end 11a and a second end 11b on the opposite sides in the axial direction.

The rotor core 11 includes a central hole 12 into which a shaft (not shown) is inserted, magnet accommodating holes 13, each accommodating a corresponding magnet 20, and cooling passages 14 through which cooling medium flows. The central hole 12, the magnet accommodating holes 13, and the cooling passages 14 extend through the rotor core 11 in the axial direction. That is, the central hole 12, the magnet accommodating holes 13, and the cooling passages 14 all open in the end face of the first end 11a and the end face of the second end 11b.

The central hole 12 is substantially circular in plan view. The inner surface of the central hole 12 has two opposing keys 12a that protrude in the radial direction. The two keys 12a are respectively fitted into key grooves in the shaft (not shown) to restrict the rotor core 11 from moving relative to the shaft in the circumferential direction.

The magnet accommodating holes 13 are located radially outward from the central hole 12, and located at equal intervals in the circumferential direction. The rotor core 11 has, for example, sixteen magnet accommodating holes 13. The opening of each magnet accommodating hole 13 has a substantially rectangular shape in plan view. Two magnet accommodating holes 13 adjacent to each other in the circumferential direction are inclined in opposite directions with respect to the circumferential direction.

The cooling passages 14 are located radially inward from the magnet accommodating holes 13, and located at equal intervals in the circumferential direction. The rotor core 11 has, for example, eight cooling passages 14.

### Magnet 20

For example, each magnet 20 is accommodated in one magnet accommodating hole 13. Instead, two magnets 20 may be accommodated in one magnet accommodating hole 13. The magnets 20 are fixed to the rotor core 11 with the resin material 30 filling the magnet accommodating holes 13.

The magnet 20 is a permanent magnet, such as a neodymium magnet.

### Resin Material 30

The resin material 30 fills, for example, the entire circumference of the magnet 20 between the inner surface of the magnet accommodating hole 13 and the outer surface of the magnet 20.

The resin material 30 may be a thermosetting resin, such as epoxy resin, or a thermoplastic resin, such as liquid crystal polymer.

### End Plate 40

The two end plates 40 include a first end plate 40A and a second end plate 40B. Hereinafter, when no distinction is made between the first end plate 40A and the second end plate 40B, they will simply be referred to as the end plate 40.

Examples of the material of the end plate 40 include a metal material such as stainless steel.

The thickness of the first end plate 40A and the thickness of the second end plate 40B are, for example, identical.

The first end plate 40A is welded to the first end 11a of the rotor core 11 to cover the end face of the first end 11a. Specifically, the outer circumferential portion of the first end plate 40A is welded to the outer circumferential portion of the first end 11a. The second end plate 40B is welded to the second end 11b to cover the end face of the second end 11b of the rotor core 11. Specifically, the outer circumferential portion of the second end plate 40B is welded to the outer circumferential portion of the second end 11b. The end plate 40 restricts the magnet 20 from protruding from the magnet accommodating hole 13.

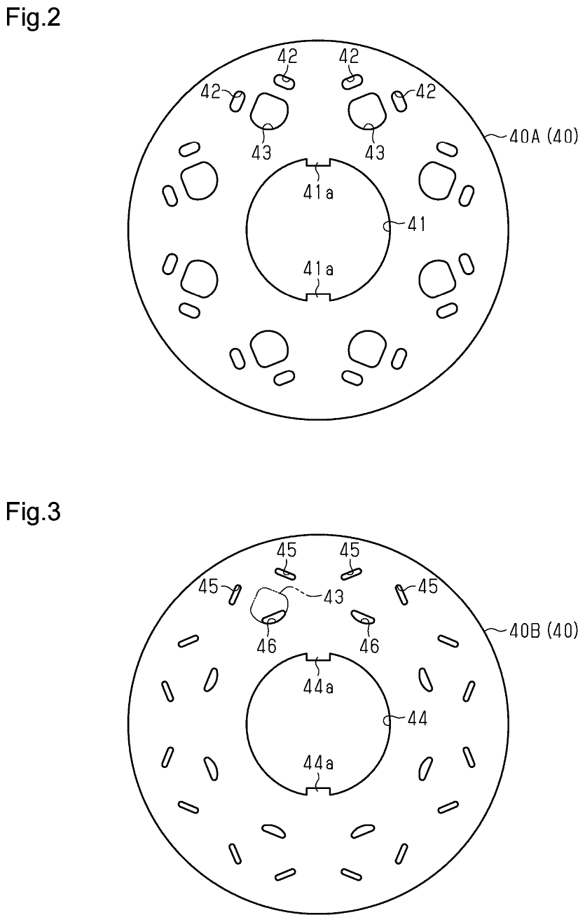

As shown in FIG. 2, the first end plate 40A has a disk shape that corresponds to the shape of the end face of the first end 11a. The first end plate 40A includes a first connection hole 41 connected to the central hole 12, second connection holes 42 respectively connected to the magnet accommodating holes 13, and third connection holes 43 respectively connected to the cooling passages 14.

The inner surface of the first connection hole 41 has two opposing first keys 41a that protrude in the radial direction. The first keys 41a are respectively shaped in correspondence with the keys 12a of the rotor core 11. The opening of each second connection hole 42 is smaller than the opening of a corresponding magnet accommodating hole 13. The opening of each third connection hole 43 is smaller than, for example, the opening of a corresponding cooling passage 14. The opening of the third connection hole 43 may be the same size as the opening of the cooling passage 14, or may be larger than the opening of the cooling passage 14. The third connection hole 43 is an example of a first through-hole.

As shown in FIG. 3, the second end plate 40B has a disk shape that corresponds to the shape of the end face of the second end 11b. The second end plate 40B includes a fourth connection hole 44 connected to the central hole 12, fifth connection holes 45 respectively connected to the magnet accommodating holes 13, and sixth connection holes 46 respectively connected to the cooling passages 14.

The inner surface of the fourth connection hole 44 has two opposing second keys 44a that protrude in the radial direction. The second keys 44a are respectively shaped in correspondence with the keys 12a of the rotor core 11. The shape of the fifth connection hole 45 differs from that of the second connection hole 42. The opening of the fifth connection hole 45 is, for example, smaller than the opening of the magnet accommodating hole 13 and smaller than the opening of the second connection hole 42. The opening of the fifth connection hole 45 may be the same size as the opening of the second connection hole 42. The shape of the sixth connection hole 46 differs from that of the third connection hole 43. The opening of the sixth connection hole 46 is smaller than the opening of the cooling passage 14 and smaller than the opening of the third connection hole 43. The sixth connection hole 46 is an example of a second through-hole.

As shown by the long dashed double-short dashed line in FIG. 3, the sixth connection hole 46 is formed in a portion of the second end plate 40B corresponding to a formation area of the third connection hole 43 of the first end plate 40A. Thus, in the rotor 10, when the first end plate 40A is projected onto the second end plate 40B, a formation area of the sixth connection hole 46 is included within the formation area of the third connection hole 43.

### Manufacturing Apparatus 50 for Rotor 10

A manufacturing apparatus 50 for the rotor 10 (hereinafter simply referred to as the manufacturing apparatus 50) will now be described.

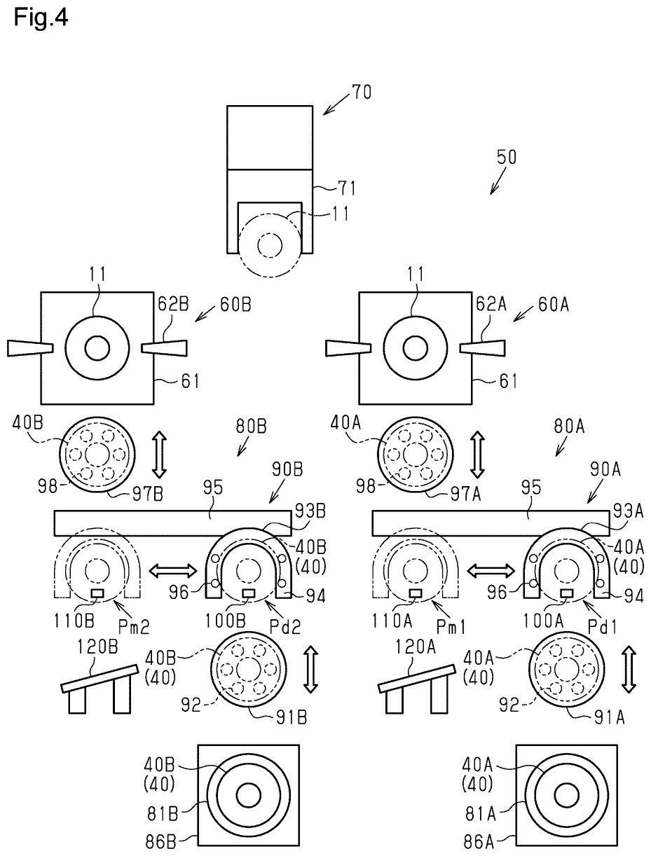

As shown in FIG. 4, the manufacturing apparatus 50 includes a first welding station 60A, a second welding station 60B, a reversing device 70, a first supply station 80A, and a second supply station 80B. At the first welding station 60A, the first end plate 40A is welded to the first end 11a of the rotor core 11, to which each magnet 20 is fixed by a corresponding resin material 30. At the second welding station 60B, the second end plate 40B is welded to the second end 11b of the rotor core 11. The reversing device 70 rotates the rotor core 11 located at the first welding station 60A and conveys it to the second welding station 60B. The first supply station 80A supplies the first end plate 40A to the first welding station 60A. The second supply station 80B supplies the second end plate 40B to the second welding station 60B.

### First Welding Station 60A

The first welding station 60A includes a welding table 61 and a first welding device 62A. The first end plate 40A supplied from the first supply station 80A is mounted onto the welding table 61. The first welding device 62A includes welding torches. The first welding device 62A is used to weld the first end plate 40A to the first end 11a of the rotor core 11 mounted on the first end plate 40A. The welding method performed by the first welding device 62A is, for example, laser welding.

### Second Welding Station 60B

The second welding station 60B includes a welding table 61 and a second welding device 62B. The second end plate 40B supplied from the second supply station 80B is mounted onto the welding table 61. The second welding device 62B includes welding torches. The second welding device 62B is used to weld the second end plate 40B to the second end 11b of the rotor core 11 mounted on the second end plate 40B. The second welding device 62B is used to weld the second end plate 40B to the second end 11b of the rotor core 11 having the first end plate 40A welded to the first end 11a. The welding method performed by the second welding device 62B is, for example, laser welding.

### Reversing Device 70

The reversing device 70 reverses the rotor core 11 with the first end plate 40A welded to the first end 11a at the first welding station 60A, and then mounts it onto the second end plate 40B at the second welding station 60B. The reversing device 70 may be configured to convey the rotor core 11 to the first welding station 60A before the first end plate 40A is welded, and extract the rotor 10 with the two welded end plates 40 from the second welding station 60B.

The reversing device 70 is, for example, a robotic arm to which a chuck 71 is attached. The chuck 71 grips the outer circumferential surface of the rotor core 11.

### First Supply Station 80A

The first supply station 80A includes a first jig 81A, a first support table 86A, a first conveying unit 90A, a first detection unit 100A, and a first thickness measurement unit 110A.

### First Jig 81A

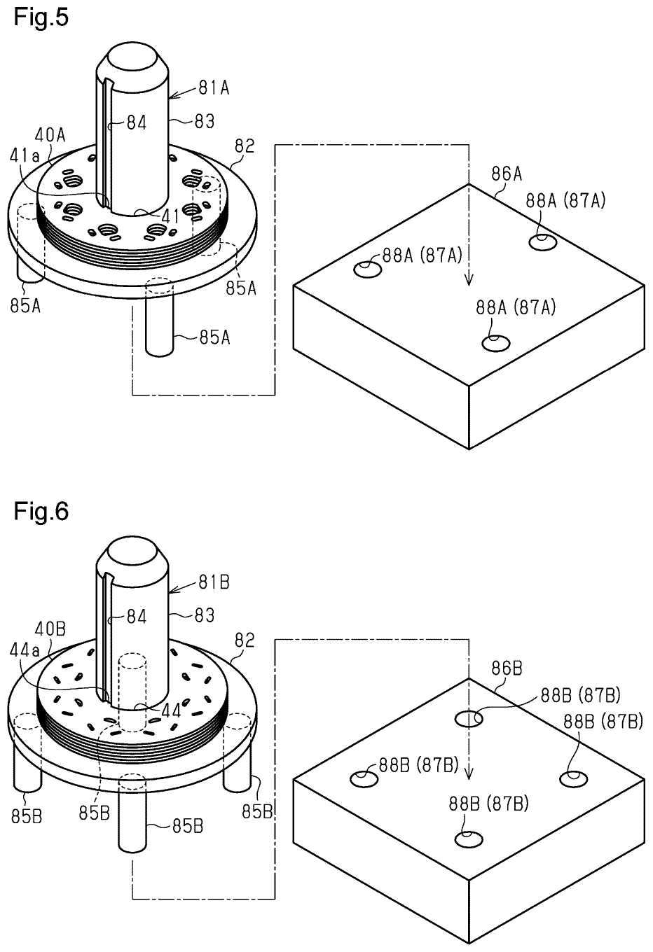

As shown in FIG. 5, the first jig 81A supports the first end plate 40A prior to being supplied to the first welding station 60A. The first jig 81A supports stacked first end plates 40A. The first jig 81A can also support the second end plates 40B.

The first jig 81A includes a mount table 82, a post 83, and first legs 85A. The first jig 81A has, for example, three first legs 85A. The mount table 82 of the first jig 81A is an example of a first mount table.

The first end plate 40A is mounted onto the mount table 82. The mount table 82 has the shape of a disk. The diameter of the mount table 82 is, for example, greater than or equal to the diameter of the first end plate 40A.

The post 83 protrudes from the central part of the mount table 82. The post 83 has a columnar shape. The post 83 is configured to be inserted into the first connection hole 41 of the first end plate 40A. The post 83 includes two grooves 84, each of which is configured to receive a corresponding one of the two first keys 41a. The two grooves 84 extend in the longitudinal direction of the post 83 on opposite sides of the central axis of the post 83.

Each first leg 85A extends from the mount table 82 toward the side opposite to the post 83. Each first leg 85A is, for instance, columnar. The three first legs 85A are spaced apart from each other in the circumferential direction around the central axis of the mount table 82. The three first legs 85A are located, for example, at equal intervals in the circumferential direction.

### First Support Table 86A

The first support table 86A includes a first engagement portion 87A that engages with the first jig 81A. The first support table 86A supports the first jig 81A by engaging the first engagement portion 87A with the first jig 81A.

The first engagement portion 87A includes first recesses 88A into which the first legs 85A are respectively inserted. The first engagement portion 87A includes the same number of first recesses 88A as the first legs 85A. Each first recess 88A is, for instance, circular in plan view. The first recesses 88A permit the insertion of the first legs 85A and restrict the insertion of second legs 85B, which will be described later. In a state in which each first leg 85A is inserted into a corresponding first recess 88A, the lower surface of the mount table 82 is in contact with the upper surface of the first support table 86A.

### First Conveying Unit 90A

Referring to FIG. 4, the first conveying unit 90A conveys an end plate 40 to the first welding station 60A. The first conveying unit 90A includes a first conveying device 91A, a second conveying device 93A, and a third conveying device 97A.

### First Conveying Device 91A

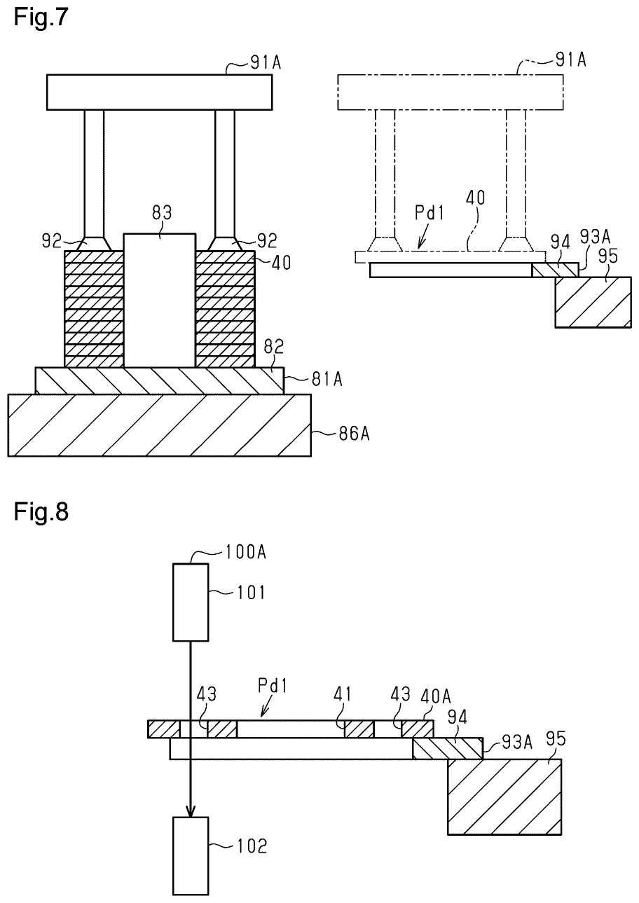

As illustrated in FIGS. 4 and 7, the first conveying device 91A conveys the end plate 40 supported by the first jig 81A to a detection position Pd1. At the detection position Pd1, the first detection unit 100A detects whether the type of the end plate 40 is the first end plate 40A.

The first conveying device 91A lifts the end plate 40 by suction using negative pressure. The first conveying device 91A includes suction pads 92 that adhere to the upper surface of the end plate 40. The first conveying device 91A may adhere to the end plate 40 in either a contact or non-contact state.

### Second Conveying Device 93A

Referring to FIG. 4, the second conveying device 93A conveys, to a thickness measurement position Pm1, the end plate 40 that has been conveyed to the detection position Pd1 by the first conveying device 91A. At the thickness measurement position Pm1, the thickness of the end plate 40 is measured by the first thickness measurement unit 110A.

The second conveying device 93A includes a support plate 94 and a linear actuator 95 that reciprocates the support plate 94 horizontally. The support plate 94 has a U-shape in plan view. The end plate 40 is mounted onto the support plate 94 by the first conveying device 91A. The support plate 94 supports the lower surface at the outer circumferential portion of the end plate 40.

The support plate 94 includes positioning pins 96 that contact the outer circumferential surface of the end plate 40 to position the end plate 40. The support plate 94 includes, for example, four positioning pins 96. Each positioning pin 96 protrudes from the upper surface of the support plate 94.

### First Detection Unit 100A

The first detection unit 100A detects whether the end plate 40 to be supplied to the first welding station 60A is the first end plate 40A. Specifically, the first detection unit 100A detects whether the end plate 40 conveyed to the detection position Pd1 by the first conveying device 91A is the first end plate 40A.

As shown in FIG. 8, the first detection unit 100A is a photoelectric sensor that includes a light emitter 101 that emits detection light and a light receiver 102 that receives the detection light. The light emitter 101 is configured to emit detection light each time the end plate 40 is conveyed to the detection position Pd1. The light receiver 102 is located, for example, below the light emitter 101.

In the first end plate 40A, the light emission area of the first detection unit 100A for the end plate 40 is the formation area of the third connection hole 43.

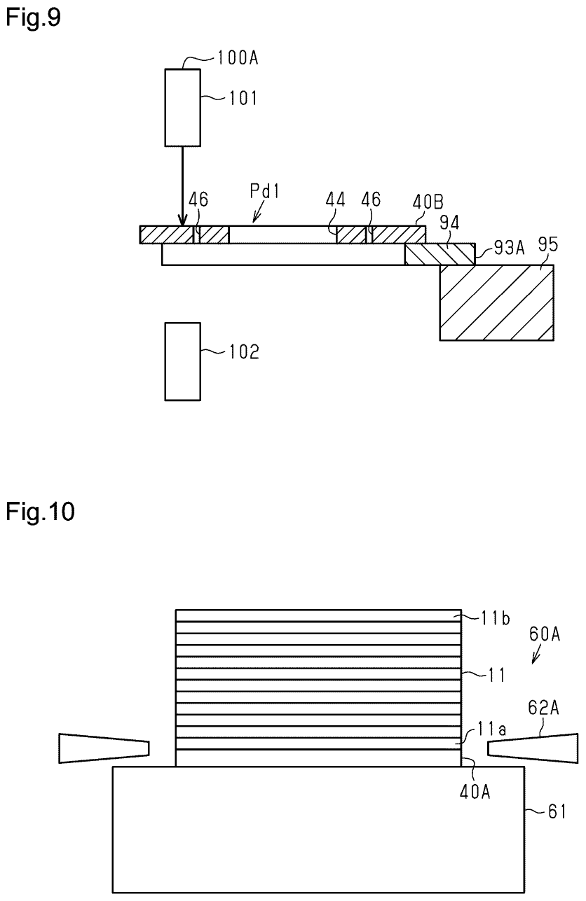

In the second end plate 40B, as shown in FIG. 9, the light emission area of the first detection unit 100A for the end plate 40 is an area that does not include the formation area of the second sixth connection hole 46 and defines a surface of the second end plate 40B. In the second end plate 40B, the light emission area of the first detection unit 100A for the end plate 40 also corresponds to the formation area of the third connection hole 43.

As shown in FIG. 8, when the end plate 40 located at the detection position Pd1 is the first end plate 40A, the detection light from the light emitter 101 passes through the third connection hole 43 and reaches the light receiver 102.

As shown in FIG. 9, when the end plate 40 located at the detection position Pd1 is the second end plate 40B, the detection light from the light emitter 101 is reflected on the surface of the second end plate 40B, and therefore does not reach the light receiver 102. When the light receiver 102 receives detection light, the first detection unit 100A detects that the end plate 40 located at the detection position Pd1 is the first end plate 40A. When the light receiver 102 does not receive detection light, the first detection unit 100A detects that the end plate 40 located at the detection position Pd1 is the second end plate 40B.

### First Thickness Measurement Unit 110A

Referring to FIG. 4, the first thickness measurement unit 110A measures the thickness of the end plate 40 that has been conveyed to the thickness measurement position Pm1 by the second conveying device 93A. The first thickness measurement unit 110A is a thickness sensor that includes two measuring devices located on the opposite sides of the end plate 40 in the thickness direction of the end plate 40. The first thickness measurement unit 110A may be configured to measure the thickness of the end plate 40 either in a contact or non-contact state.

### Third Conveying Device 97A

Based on the detection result from the first detection unit 100A and the measurement result from the first thickness measurement unit 110A, the third conveying device 97A conveys the end plate 40 located at the thickness measurement position Pm1 to the first welding station 60A or a discharge chute 120A. The discharge chute 120A is designed to discharge the end plate 40 out of the manufacturing apparatus 50 using its own weight. For example, the discharge chute 120A includes a trough-shaped inclined platform that is inclined with respect to the horizontal direction.

The third conveying device 97A lifts the end plate 40 by suction using negative pressure. The third conveying device 97A includes suction pads 98 that adhere to the upper surface of the end plate 40. The third conveying device 97A may adhere to the end plate 40 in either a contact or non-contact state.

### Second Supply Station 80B

The second supply station 80B has the same configuration as, or a corresponding configuration to, the first supply station 80A.

Hereinafter, in describing the configuration of the second supply station 80B, the same reference numerals will be used for components identical to those in the first supply station 80A, and redundant explanations may be omitted. For components in the second supply station 80B that correspond to those in the first supply station 80A, redundant explanations may be omitted by changing the suffix of the reference numerals indicating the components of the first supply station 80A from A to B.

The second supply station 80B includes a second jig 81B, a second support table 86B, a second conveying unit 90B, a second detection unit 100B, and a second thickness measurement unit 110B.

### Second Jig 81B

As shown in FIG. 6, the second jig 81B supports the second end plate 40B prior to being supplied to the second welding station 60B. The second jig 81B supports stacked second end plates 40B. The second jig 81B can also support the first end plate 40A.

The second jig 81B includes a mount table 82, a post 83, and second legs 85B. The second jig 81B, for example, includes four second legs 85B. The mount table 82 of the second jig 81B is an example of a second mount table.

Each second leg 85B extends from the mount table 82 toward the side opposite to the post 83. Each second leg 85B is, for instance, columnar. The three second legs 85B are spaced apart from each other in the circumferential direction around the central axis of the mount table 82. The four legs are located, for example, at equal intervals in the circumferential direction.

### Second Support Table 86B

The second support table 86B includes a second engagement portion 87B that engages with the second jig 81B. The second support table 86B supports the second jig 81B by engaging the second engagement portion 87B with the second jig 81B.

The second engagement portion 87B includes second recesses 88B into which the second legs 85B are respectively inserted. The second engagement portion 87B includes the same number of second recesses 88B as the second legs 85B. Each second recess 88B is, for example, circular in plan view. The second recesses 88B permit the insertion of the second legs 85B and restrict the insertion of the first legs 85A. In a state in which each second leg 85B is inserted into a corresponding second recess 88B, the lower surface of the mount table 82 is in contact with the upper surface of the second support table 86B.

### Second Conveying Unit 90B

Referring to FIG. 4, the second conveying unit 90B conveys an end plate 40 to the second welding station 60B. The second conveying unit 90B includes a first conveying device 91B, a second conveying device 93B, and a third conveying device 97B.

### First Conveying Device 91B

The first conveying device 91B conveys the end plate 40 supported by the second jig 81B to a detection position Pd2. At the detection position Pd2, the second detection unit 100B detects whether the type of the end plate 40 is the second end plate 40B.

### Second Conveying Device 93B

The second conveying device 93B conveys, to a thickness measurement position Pm2, the end plate 40 that has been conveyed to the detection position Pd2 by the first conveying device 91B. At the thickness measurement position Pm2, the thickness of the end plate 40 is measured by the second thickness measurement unit 110B.

### Second Detection Unit 100B

The second detection unit 100B detects whether the end plate 40 to be supplied to the second welding station 60B is the second end plate 40B. Specifically, the second detection unit 100B detects whether the end plate 40 conveyed to the detection position Pd2 by the first conveying device 91B is the second end plate 40B.

The second detection unit 100B has the same components as the first detection unit 100A. Specifically, the second detection unit 100B is a photoelectric sensor that includes a light emitter 101 and a light receiver 102.

When the light receiver 102 receives detection light, the second detection unit 100B detects that the end plate 40 located at the detection position Pd2 is the first end plate 40A. When the light receiver 102 does not receive detection light, the second detection unit 100B detects that the end plate 40 located at the detection position Pd2 is the second end plate 40B.

### Second Thickness Measurement Unit 110B

The second thickness measurement unit 110B measures the thickness of the end plate 40 that has been conveyed to the thickness measuring position Pm2 by the second conveying device 93B.

### Third Conveying Device 97B

Based on the detection result from the second detection unit 100B and the measurement result from the second thickness measurement unit 110B, the third conveying device 97B conveys the end plate 40 located at the thickness measurement position Pm2 to the second welding station 60B or a discharge chute 120B.

### Method for Manufacturing Rotor 10

The method for manufacturing the rotor 10 will now be described.

The method for manufacturing the rotor 10 includes a first conveying step, a first detecting step, a first thickness measuring step, a first welding step, a second conveying step, a second detecting step, a second thickness measuring step, a second welding step, and a reversing step.

Referring to FIG. 4, in the first conveying step, the first conveying unit 90A conveys the end plate 40 supported by the first jig 81A to the detection position Pd1 and then to the thickness measurement position Pm1. Subsequently, the first conveying unit 90A conveys the end plate 40 located at the thickness measurement location Pm1 to the first welding station 60A or the discharge chute 120A. Prior to the first conveying step, the first jig 81A supporting multiple end plates 40 is engaged with the first support table 86A by, for example, an operator.

Referring to FIG. 7, in the first conveying step, the first conveying device 91A first suctions and lifts the topmost end plate 40 stacked on the first jig 81A. Subsequently, the first conveying device 91A conveys the end plate 40 to the detection position Pd1 by mounting the end plate 40 onto the support plate 94 of the second conveying device 93A.

Referring to FIG. 4, after the end plate 40 is conveyed to the detection position Pd1, the first detecting step is performed. In the first detecting step, the first detection unit 100A detects whether the end plate 40 to be supplied to the first welding station 60A by the first conveying unit 90A is the first end plate 40A.

In the first conveying step performed after the first detecting step, the second conveying device 93A moves the support plate 94 to convey the end plate 40 from the detection position Pd1 to the thickness measurement position Pm1. The second conveying device 93A conveys the end plate 40 from the detection position Pd1 to the thickness measurement position Pm1, regardless of the detection result from the first detecting step.

After the end plate 40 is conveyed to the thickness measurement position Pm1, the first thickness measuring step is performed. In the first thickness measuring step, the first thickness measurement unit 110A measures the thickness of the end plate 40. When the detection result of the first detecting step is the second end plate 40B, the first thickness measuring step does not have to be performed.

Subsequently, in the first conveying step, the third conveying device 97A suctions and lifts the end plate 40 located at the thickness measurement position Pm1. Then, the third conveying device 97A conveys the end plate 40 to the first welding station 60A or the discharge chute 120A, based on the detection result from the first detecting step and the measurement result from the first thickness measuring step.

It is preferable that the end plates 40 are conveyed one by one by the first conveying unit 90A; however, there is a risk that the end plates 40 may be conveyed in an overlapped state. If the first end plates 40A are overlapped with each other, the detection result from the first detection unit 100A is the first end plate 40A. In this case, the measurement result from the first thickness measurement unit 110A is greater than a predetermined first threshold value Th1. The first threshold value Th1 is set to, for example, the maximum value within the manufacturing tolerance range for the thickness of the first end plate 40A. In other words, when the measurement result from the first thickness measurement unit 110A is greater than the first threshold value Th1, it indicates that the end plates 40 are overlapped with each other.

When the detection result from the first detection unit 100A is the first end plate 40A and the measurement result from the first thickness measurement unit 110A is less than or equal to the first threshold value Th1, the third conveying device 97A conveys the first end plate 40A to the first welding station 60A. In this state, the third conveying device 97A mounts the first end plate 40A onto the welding table 61 of the first welding station 60A.

When the detection result from the first detection unit 100A is the first end plate 40A but the measurement result from the first thickness measurement unit 110A is greater than the first threshold value Th1, the third conveying device 97A suspends the conveyance of the first end plate 40A to the first welding station 60A. Further, when the detection result from the first detection unit 100A is the second end plate 40B, the third conveying device 97A suspends the conveyance of the second end plate 40B to the first welding station 60A. When suspending the conveyance of the end plate 40 to the first welding station 60A, the third conveying device 97A conveys the end plate 40 located at the thickness measurement position Pm1 to the discharge chute 120A.

As shown in FIG. 10, prior to the first welding step, the reversing device 70 mounts the rotor core 11 onto the first end plate 40A which has been mounted on the welding table 61 of the first welding station 60A. As a result, the first end 11a of the rotor core 11 comes into contact with the upper surface of the first end plate 40A.

In the first welding step, the first welding device 62A welds the first end plate 40A to the first end 11a of the rotor core 11.

The second conveying step, second detecting step, second thickness measuring step, and second welding step respectively correspond to the aforementioned first conveying step, first detecting step, first thickness measuring step, and first welding step. The second conveying step, second detecting step, second thickness measuring step, and second welding step may be described by substituting the corresponding steps in the description of the first conveying step, first detecting step, first thickness measuring step, and first welding step. Specifically, the detection position Pd1 may be substituted with detection position Pd2, the thickness measurement position Pm1 with thickness measurement position Pm2, the first threshold value Th1 with the second threshold value Th2, the prefix “first” in the name of each component with “second,” and the suffix “A” in the reference numeral of each component with “B.” The second threshold value Th2 is set to, for example, the maximum value within the manufacturing tolerance range for the thickness of the second end plate 40B. The first threshold value Th1 and the second threshold value Th2 are set to, for example, the same value.

In the reversing step, the reversing device 70 reverses the rotor core 11 to which the first end plate 40A has been welded, and mounts it onto the second end plate 40B that has been mounted on the welding table 61 of the second welding station 60B. As a result, the second end 11b of the rotor core 11 comes into contact with the upper surface of the second end plate 40B. The reversing step is performed after the first welding step and the second conveying step and before the second welding step.

In the manner described as above, the rotor 10 is manufactured by welding the first end plate 40A to the first end 11a of the rotor core 11 and the second end plate 40B to the second end 11b of the rotor core 11.

The operation and advantages of the present embodiment will now be described.

(1) The manufacturing apparatus 50 includes the first welding device 62A and the first detection unit 100A, which detects whether the end plate 40 to be supplied to the first welding device 62A is the first end plate 40A. Further, the manufacturing apparatus 50 includes the second welding device 62B and the second detection unit 100B, which detects whether the end plate 40 to be supplied to the second welding device 62B is the second end plate 40B.

In this configuration, the first detection unit 100A determines whether the end plate 40 to be supplied to the first welding device 62A is the first end plate 40A. Further, the second detection unit 100B determines whether the end plate 40 to be supplied to the second welding device 62B is the second end plate 40B. Thus, an end plate 40 that differs from the standard one is prevented from being welded to the rotor core 11. Accordingly, erroneous coupling of the end plate 40 is prevented.

(2) In the first end plate 40A, the light emission area of the first detection unit 100A and the second detection unit 100B for the end plate 40 is the formation area of the third connection hole 43. In the second end plate 40B, this light emission area is an area that does not include the formation area of the second sixth connection hole 46 and defines the surface of the second end plate 40B.

In this configuration, the detection light emitted to the first end plate 40A passes through the first end plate 40A via the third connection hole 43, and the detection light emitted to the second end plate 40B is reflected on the surface of the second end plate 40B. As a result, the first detection unit 100A and the second detection unit 100B detect whether the end plate 40 welded to the rotor core 11 is the standard one. Accordingly, erroneous coupling of the end plate 40 is readily prevented.

(3) When detecting that the end plate 40 to be conveyed to the first welding station 60A is not the first end plate 40A, the first conveying unit 90A suspends the conveyance of that end plate 40 to the first welding station 60A. When detecting that the end plate 40 to be conveyed to the second welding station 60B is not the second end plate 40B, the second conveying unit 90B suspends the conveyance of that end plate 40 to the second welding station 60B.

In this configuration, when the end plate 40 to be conveyed by the first conveying unit 90A and the second conveying unit 90B differs from the standard one, the conveyance of the end plate 40 to the first welding station 60A and the second welding station 60B is suspended. Thus, an end plate 40 that differs from the standard one is prevented from being welded to the rotor core 11. Accordingly, erroneous coupling of the end plate 40 is prevented.

(4) When the measurement result from the first thickness measurement unit 110A is greater than the predetermined first threshold value Th1, the first conveying unit 90A suspends the conveyance of the end plate 40 to the first welding station 60A. When the measurement result from the second thickness measurement unit 110B is greater than the predetermined second threshold value Th2, the second conveying unit 90B suspends the conveyance of the end plate 40 to the second welding station 60B.

In this configuration, when the first threshold value Th1 is set to the maximum value within the manufacturing tolerance range for the thickness of each first end plate 40A, multiple first end plates 40A are prevented from being conveyed to the first welding station 60A in an overlapped state. Similarly, when the second threshold value Th2 is set to the maximum value within the manufacturing tolerance range for the thickness of each second end plate 40B, multiple second end plates 40B are prevented from being conveyed to the second welding station 60B in an overlapped state.

(5) The manufacturing apparatus 50 includes the first jig 81A, which supports the first end plate 40A, and the first support table 86A, which includes the first engagement portion 87A. The first engagement portion 87A engages with the first jig 81A. The manufacturing apparatus 50 includes the second jig 81B, which supports the second end plate 40B, and the second support table 86B, which includes the second engagement portion 87B. The second engagement portion 87B engages with the second jig 81B. The first engagement portion 87A permits engagement with the first jig 81A and restricts engagement with the second jig 81B. The second engagement portion 87B permits engagement with the second jig 81B and restricts engagement with the first jig 81A.

In this configuration, the first jig 81A supporting the first end plate 40A engages with the first engagement portion 87A and does not engage with the second engagement portion 87B. Further, the second jig 81B supporting the second end plate 40B engages with the second engagement portion 87B and does not engage with the first engagement portion 87A. This prevents the first jig 81A from being supported by the second support table 86B and prevents the second jig 81B from being supported by the first support table 86A. Accordingly, when the end plate 40 that has been extracted from the first jig 81A supported by the first support table 86A is supplied to the first welding station 60A, erroneous coupling of the end plate 40 is prevented. Further, when the end plate 40 that has been extracted from the second jig 81B supported by the second support table 86B is supplied to the second welding station 60B, erroneous coupling of the end plate 40 is prevented.

In the present embodiment, the first end plate 40A can be supported by the second jig 81B, and the second end plate 40B can be supported by the first jig 81A. Even if the first end plate 40A is supported by the second jig 81B, that first end plate 40A is detected by the second detection unit 100B. This prevents erroneous coupling in which the first end plate 40A is welded to the second end 11b. The same applies to the second end plate 40B.

(6) The first engagement portion 87A includes the first recesses 88A, which permit the insertion of the first legs 85A of the first jig 81A and restrict the insertion of the second legs 85B of the second jig 81B. The second engagement portion 87B includes the second recesses 88B, which permit the insertion of the second legs 85B of the second jig 81B and restrict the insertion of the first legs 85A of the first jig 81A.

In this configuration, the first jig 81A can be readily supported by the first support table 86A by respectively inserting the first legs 85A into the first recesses 88A. Further, the second jig 81B can be readily supported by the second support table 86B by respectively inserting the second legs 85B into the second recesses 88B.

(7) In the first welding step, the first welding device 62A is used to weld the first end plate 40A to the first end 11a. The first detecting step detects whether the end plate 40 to be supplied to the first welding station 60A is the first end plate 40A. In the second welding step, the second welding device 62B is used to weld the second end plate 40B to the second end 11b of the rotor core 11 having the first end plate 40A welded to the first end 11a. The second detecting step detects whether the end plate 40 to be supplied to the second welding station 60B is the second end plate 40B.

In such a method, the first detecting step detects whether the end plate 40 to be welded to the first end 11a of the rotor core 11 is the first end plate 40A. Further, the second detecting step detects whether the end plate 40 to be welded to the second end 11b of the rotor core 11 is the second end plate 40B. Thus, the first welding step and the second welding step prevent an end plate 40 that differs from the standard one from being welded to the rotor core 11. Accordingly, erroneous coupling of the end plate 40 is prevented.

### Modifications

The present embodiment may be modified as follows. The present embodiment and the following modifications can be combined as long as the combined modifications remain technically consistent with each other.

The first jig 81A may have at least one first leg 85A, and the first support table 86A may have at least one first recess 88A. Similarly, the second jig 81B may have at least one second leg 85B, and the second support table 86B may have at least one second recess 88B.

The shapes or sizes of the first leg 85A and the second leg 85B may differ from each other. In this case, the first recess 88A and the second recess 88B only need to have a shape or size that corresponds to those of the first leg 85A and the second leg 85B.

The first jig 81A and the second jig 81B do not have to include the first legs 85A and the second legs 85B, respectively. In this case, if the shapes or sizes of the mount tables 82 of the first jig 81A and the second jig 81B differ from each other, the first engagement portion 87A may be shaped to permit engagement with the mount table 82 of the first jig 81A and restrict engagement with the mount table 82 of the second jig 81B. Similarly, the second engagement portion 87B may be shaped to permit engagement with the mount table 82 of the second jig 81B and restrict engagement with the mount table 82 of the first jig 81A.

The first jig 81A may have a support pillar protruding from the central part of the mount table 82 to the side opposite to the post 83, and the first engagement portion 87A of the first support table 86A may have an insertion hole into which the support pillar is inserted. Preferably, the protrusion length of the support pillar from the mount table 82 is greater than the protrusion length of each first leg 85A from the mount table 82. In this configuration, after the support pillar is inserted into the insertion hole, the first legs 85A are respectively inserted into the first recesses 88A. As a result, compared to a configuration without a support pillar, the first jig 81A can be supported by the first support table 86A more easily. The above-described modifications can be applied to the second jig 81B and the second support table 86B in the same manner.

The manufacturing apparatus 50 does not have to include the first support table 86A and the second support table 86B.

The manufacturing apparatus 50 does not have to include the first jig 81A and the second jig 81B. In this case, for example, the operator may supply the end plate 40 to the first welding device 62A and the second welding device 62B.

When the thickness of the first end plate 40A is different from the thickness of the second end plate 40B, the first threshold value Th1 and the second threshold value Th2 may each be set to a different value.

The manufacturing apparatus 50 does not have to include the first thickness measurement unit 110A and the second thickness measurement unit 110B.

When detecting that the end plate 40 to be conveyed to the first welding station 60A is not the first end plate 40A, the first conveying unit 90A may stop conveying that end plate 40 to the first welding station 60A by stopping the conveyance operation. Similarly, when detecting that the end plate 40 to be conveyed to the second welding station 60B is not the second end plate 40B, the second conveying unit 90B may stop conveying that end plate 40 to the second welding station 60B by stopping the conveyance operation. In such cases, for example, the operator may extract an end plate 40 that is different from the standard one from the manufacturing apparatus 50.

The light receiver 102 may be located on the same side as the light emitter 101 as viewed from the end plate 40. In this case, the detection light reflected on the surface of the end plate 40 is received by the light receiver 102. In this configuration, when the light receiver 102 does not receive detection light, the first detection unit 100A detects that the end plate 40 located at the detection position Pd1 is the first end plate 40A. Further, when the light receiver 102 receives detection light, the first detection unit 100A detects that the end plate 40 located at the detection position Pd1 is the second end plate 40B. These modifications can be applied to the second detection unit 100B in the same manner.

The third connection hole 43, which is an example of the first through-hole, and the sixth connection hole 46, which is an example of the second through-hole, may have the same shape but differ in size. That is, the shape of the third connection hole 43 and the shape of the sixth connection hole 46 may be geometrically similar to each other.

The second connection hole 42 and the fifth connection hole 45 may respectively be designated as the second through-hole and the first through-hole, thereby setting the light emission areas of the first detection unit 100A and the second detection unit 100B for the end plate 40.

The first detection unit 100A and the second detection unit 100B may detect the type of the end plate 40 by detecting whether the outer circumferential surface of the end plate 40 include a recess.

The first detection unit 100A and the second detection unit 100B may detect the type of end plate 40 based on the capture data from a camera that photographs the end plate 40. In this case, the first detection unit 100A and the second detection unit 100B may detect the type of end plate 40 by identifying characters, patterns, or two-dimensional codes displayed on the surface of the end plate 40.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rotor manufacturing apparatus for manufacturing a rotor that includes a rotor core with a first end and a second end located on opposite sides in an axial direction and includes two end plates respectively welded to the first end and the second end, the two end plates each having a different shape, the end plate welded to the first end being referred to as a first end plate, and the end plate welded to the second end being referred to as a second end plate, the rotor manufacturing apparatus comprising:
a first welding device configured to weld the first end plate to the first end;
a first detection unit configured to detect whether an end plate to be supplied to the first welding device is the first end plate;
a second welding device configured to weld the second end plate to the second end of the rotor core having the first end plate welded to the first end; and
a second detection unit configured to detect whether an end plate to be supplied to the second welding device is the second end plate.

2. The rotor manufacturing apparatus according to claim 1, wherein
the first end plate has a first through-hole,
the second end plate has a second through-hole with a shape or size different from a shape or size of the first through-hole,
each of the first detection unit and the second detection unit is a photoelectric sensor that includes a light emitter configured to emit detection light and a light receiver configured to receive the detection light, and
a light emission area of the first detection unit and the second detection unit for the end plate is, in the first end plate, a formation area of the first through-hole and is, in the second end plate, an area that does not include a formation area of the second through-hole and defines a surface of the second end plate.

3. The rotor manufacturing apparatus according to claim 1, further comprising:
a first conveying unit configured to convey an end plate to the first welding device; and
a second conveying unit configured to convey an end plate to the second welding device, wherein
the first detection unit is configured to detect whether the end plate to be conveyed to the first welding device by the first conveying unit is the first end plate,
the second detection unit is configured to detect whether the end plate to be conveyed to the second welding device by the second conveying unit is the second end plate,
the first conveying unit is configured to suspend the conveyance of the end plate to the first welding device when detecting that the end plate to be conveyed to the first welding device is not the first end plate, and
the second conveying unit is configured to suspend the conveyance of the end plate to the second welding device when detecting that the end plate to be conveyed to the second welding device is not the second end plate.

4. The rotor manufacturing apparatus according to claim 3, further comprising:
a first thickness measurement unit configured to measure a thickness of the end plate detected as the first end plate by the first detection unit;
a second thickness measurement unit configured to measure a thickness of the end plate detected as the second end plate by the second detection unit, wherein
the first conveying unit is configured to suspend the conveyance of the end plate to the first welding device when a measurement result from the first thickness measurement unit is greater than a predetermined first threshold value; and
the second conveying unit is configured to suspend the conveyance of the end plate to the second welding device when a measurement result from the second thickness measurement unit is greater than a predetermined second threshold value.

5. The rotor manufacturing apparatus according to claim 1, further comprising:
a first jig configured to support the first end plate prior to being supplied to the first welding device;
a first support table including a first engagement portion that engages with the first jig and supporting the first jig;
a second jig configured to support the second end plate prior to being supplied to the second welding device; and
a second support table including a second engagement portion that engages with the second jig and supporting the second jig, wherein
the first engagement portion permits engagement with the first jig and restricts engagement with the second jig, and
the second engagement portion permits engagement with the second jig and restricts engagement with the first jig.

6. The rotor manufacturing apparatus according to claim 5, wherein
the first jig includes:
a first mount table configured such that the first end plate is mounted on the first mount table; and
a first leg extending from the first mount table,
the second jig includes:
a second mount table configured such that the second end plate is mounted on the second mount table; and
a second leg extending from the second mount table,
the first engagement portion includes a first recess that permits insertion of the first leg and restricts insertion of the second leg, and
the second engagement portion includes a second recess that permits insertion of the second leg and restricts insertion of the first leg.

7. A rotor manufacturing method for manufacturing a rotor that includes a rotor core with a first end and a second end located on opposite sides in an axial direction and includes two end plates respectively welded to the first end and the second end, the two end plates each having a different shape, the end plate welded to the first end being referred to as a first end plate, and the end plate welded to the second end being referred to as a second end plate, the rotor manufacturing method comprising:
welding the first end plate to the first end using a first welding device;
detecting whether an end plate to be supplied to the first welding device is the first end plate;
welding, using the second welding device, the second end plate to the second end of the rotor core having the first end plate welded to the first end; and
detecting whether an end plate to be supplied to the second welding device is the second end plate.
